(19) United States
(12) Patent Application Publication
(10) Pub. No.: US 2025/0365484 A1
(43) Pub. Date: Nov. 27, 2025

(54) DEVICES, SYSTEMS, AND METHODS FOR MEASURING DIRECTIONALLY AND SPATIALLY RESOLVED SHORTWAVE RADIATION

(71) Applicant: The Trustees of Princeton University, Princeton, NJ (US)

(72) Inventors: Coleman Merchant, Branchburg, NJ (US); Forrest Meggers, Princeton, NJ (US)

(73) Assignee: The Trustees of Princeton University, Princeton, NJ (US)

(21) Appl. No.: 18/866,813

(22) PCT Filed: May 19, 2023
(86) PCT No.: PCT/US2023/022836

§ 371 Date: Nov. 18, 2024

Related U.S. Application Data
(60) Provisional application No. 63/343,602, filed on May 19, 2022.

(51) Int. Cl. H04N 23/11; G01J 1/02; G01J 1/04; G01J 1/42; G01J 5/02; G01J 5/04; G01J 5/0804; G01J 5/0875; G01J 5/10; H04N 23/13; H04N 23/23; H04N 23/55

(52) U.S. Cl. CPC H04N 23/11; G01J 1/0271; G01J 1/0411; G01J 1/044; G01J 1/429; G01J 5/0205; G01J 5/045; G01J 5/0804; G01J 5/0875; G01J 5/10; H04N 23/13; H04N 23/23; H04N 23/55; G01J 2005/106

(57) ABSTRACT

Disclosed is a device that will take radiometric images of the shortwave spectrum from 0.2-2 μm, which can then be processed into a spherical panoramic image. This single source of data can then be used to produce a wide range of functional outputs for radiative energy analysis, from architectural performance and thermal comfort analysis to replacing the array of sensors required to make specific biometeorological measurements, such as Global Horizontal Irradiance (GHI), Direct Normal Irradiance (DNI), Diffuse Horizontal Irradiance (DHI), Sky View Factor (SVF), and/or Global Tilted Irradiance (GTI). The data is also combined with a longwave array detector to produce full-spectrum radiative energy measurements.

### CROSS-REFERENCE TO RELATED APPLICATIONS

The present application claims priority to U.S. 63/343,602, filed May 19, 2022, the contents of which are incorporated by reference herein in its entirety.

### TECHNICAL FIELD

The present disclosure is drawn to techniques for measuring radiation, and specifically techniques for determining planar irradiance values across substantially all of the full spectrum (generally about 0.2 to about 2 μm) of shortwave radiation at once.

### BACKGROUND

The measurement of heat impacts on people in the built environment is critical to understanding and addressing issues of human health, climate, and urban design. Climate change is increasing average temperatures across the globe, with the most recent Intergovernmental Panel on Climate Change (IPCC) assessment reporting a higher average temperature increase across the last century of 1.59° C. over land compared to ocean, and additionally stating that cities will intensify human-induced warming locally. Heat is also increasing even more in urban areas due to radiative trapping and anthropogenic emissions of heat. These temperature increases all represent surface air temperatures. As is known in the art, surface temperatures can easily be >30° C. warmer than air temperatures reaching extremes above 60° C.

The general population largely associates heat with air temperatures, but in warm climates the majority of heat experienced by people in the urban environment is in the form of radiant heat transfer. Human body heat models and experimental radiant pavilions have been created, which have both demonstrated how as air temperatures approach skin temperature the body's necessary metabolic heat rejection can become almost completely dependent on radiant heat transfer.

Radiant heat transfer is the exchange of heat by the emission and absorption of electromagnetic radiation between surfaces. Governed by blackbody radiation physics described by Planck, the temperature of surfaces drives the emission of thermal radiation, including between people and their surroundings. Radiant heat transfer occurs across the full spectrum of radiation, and as the emission is related to temperatures there are two dominant modes of radiant heat experienced: solar shortwave radiation and terrestrial longwave radiation. The sun, at around 5000 K, emits shortwave light peeking around 0.5-1 micron wavelengths that humans have evolved to see with their eyes, but that also brings around 1 kW·m⁻² to the surface of the Earth. The Earth, including those humans existing on it, are only around 300K and therefore emit largely in the longwave wavelengths of 8-15 micron, creating a dynamic exchange between surfaces on the planet that is invisible to the human eye.

For shortwave radiation there is an intuitive association of heat felt from the intense solar direct beam, and an understanding that black materials (low albedo and heat absorption) will absorb more of this heat than white materials (high albedo and heat reflection). The longwave radiation is not visible to the human eye and it is not transmitted via an intense direct beam, but rather is diffusely emitted and exchanged between surfaces, which makes the view factor to surrounding surfaces and their varying temperatures critical in understanding radiant heat impacts. While finding shade from the sun is an obvious strategy to reduce radiant heat, it is nearly impossible for a human to adapt to the diffuse longwave heat surrounding them in the urban environment. In addition, even in the shade the diffuse shortwave radiation that diffusely reflects off high-albedo surfaces is also non-trivial.

There is currently no method that satisfactorily can measure shortwave irradiance across the full spectrum (generally from about 0.2 to about 2 μm) at once. Current ‘quantum’ imagers like charge-coupled device (CCD) cameras, complementary metal-oxide semiconductor (CMOS) cameras, and InGaAs detectors are only sensitive to narrow regions of the spectrum, and so fail to provide accurate overall radiative energy accountings from the highly varied spectral emissions and reflections present.

### BRIEF SUMMARY

Various deficiencies in the prior art are addressed below by the disclosed devices, systems, and methods.

In various aspects, a device for measuring directionally and spatially resolved shortwave radiation may be provided. The device may include a bare thermal sensor array detector, having a plurality of pixels (such as, e.g., between 64 and 5,000,000 pixels). The device may include a lens assembly configured to pass shortwave radiation from about 0.2 to about 2 μm in wavelength to the bare thermal sensor array detector.

The device may include a plurality of housings removably coupled together. The housings (as a combined unit) may at least partially surround the bare thermal sensor array detector and the lens assembly. The housings (as a combined unit) may define at least one opening configured to allow short wave radiation to reach the lens assembly.

The lens assembly may include an achromatic optical float glass lens pair with a visible light/near infrared (VIS-NIR) anti-reflection coating. The device may include a shutter configured to have a first position and a second position, such that shortwave radiation is prevented from reaching the lens assembly in the first position and allowed to reach the lens assembly in a second position. The shutter may be operably coupled to a servo, where the servo may be configured to cause the shutter to move from the first position to the second position.

The device may include a lens shade coupled to at least one of the plurality of housings, where the lens shade may be configured to extend away from the at least one opening, such as along an axis normal to a detection surface of the bare thermal sensor array detector. The device may include a window (which may be composed of, e.g., CaF₂) that at least partially seals the bare thermal sensor array detector. The device may include a 2-axis pan/tilt assembly configured to have 360 degrees of motion in an azimuthal direction and 180 degrees of motion in elevation. The device may include one or more processor(s), where the processor(s), as a collective, may be configured to receive images from the bare thermal sensor array detector. The processor(s), as a collective, may be configured to receive multiple images from the bare thermal sensor array detector and stitch the images together to form one composite image.

In various aspects, a system for measuring radiation may be provided. The system may include a device for measuring directionally and spatially resolved shortwave radiation as disclosed herein. The system may also include a longwave array detector. The two may be operably coupled to one or more processor(s). The processor(s) may be configured to receive images from the bare thermal sensor array detector and from the longwave array detector, and combine the images to form a composite image.

In various aspects, a method for determining planar irradiance values may be provided. The method may include receiving a first set of images from a device for measuring directionally and spatially resolved shortwave radiation as disclosed herein. The method may include processing the first plurality of images to evenly distribute pixel data points such that every pixel value in a 3D vector space has an equal solid-angle view factor. The method may include storing a matrix of corresponding 3D vector coordinates. The method may include generating planar irradiance values based on the plurality of images and the matrix.

The method may include receiving a second set of images from a longwave array detector, the second set of images substantially overlapping the first plurality of images. The method may include mapping at least one pixel from the second set of images to correspond to at least one pixel from the first plurality of images.

The method may include performing various tasks with the combined first and second set of data. For example, the method may include determining at least one biometeorology measurement (such as Global Horizontal Irradiance (GHI), Direct Normal irradiance (DNI), Diffuse Horizontal Irradiance (DHI), Sky View Factor (SVF), Global Tilted Irradiance (GTI), or a combination thereof) based on the measured and resolved full spectrum of shortwave and longwave radiation. The method may include classifying pixel(s) by comparing a shortwave radiation value from a given pixel to a longwave radiation value mapped to that pixel. The method may include performing at least one heat transfer analysis based on the first plurality of images and the second plurality of images.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is an illustration of a cross-sectional view of a device.

FIG. 2 is a simplified illustration of a system.

FIG. 3 is a flowchart of a method.

FIG. 4 is an illustration of a mobile human-biometeorological station (MaRTy cart).

FIG. 5 is a representation of an image, originally in color, demonstrating pixel categorization at Hayden Lawn on a combined longwave and shortwave irradiance image.

FIG. 6A-6D are images showing, at Forest Avenue, shortwave (e.g., ˜0.2 to ˜2 μm) (6A, 6C) and Longwave (here, 7.7-20 μm) (6B, 6D) panorama at 11 am (6A, 6B) and 3 pm (6C, 6D) from an embodiment of a disclosed system.

FIGS. 7A-7B are images showing, at Hayden Lawn, shortwave (7A) and Longwave (7B) radiant energy panorama at 2 μm from an embodiment of a disclosed system.

FIG. 8A-8B are images showing, at MUPV canopy, shortwave (8A) and Longwave (8B) radiant energy panorama at 2 μm from an embodiment of a disclosed system.

FIG. 9 is a graph showing reflected shortwave variation across time and planar direction at Forest Ave, including simulation data (SIM), and from the ratio of reflected ground to direct sky measurements taken from an embodiment of a disclosed system.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

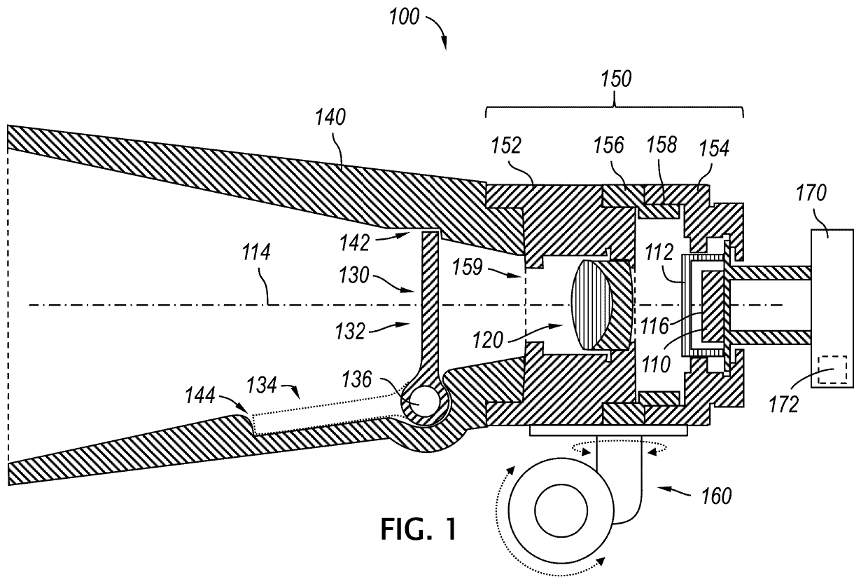

In various aspects, a device for measuring directionally and spatially resolved shortwave radiation may be provided. Referring to FIG. 1, the device 100 may include a bare thermal sensor array detector 110 configured to have a plurality of pixels. As used herein, the term “bare” detector indicates a lensless, unfiltered detector.

The plurality of pixel may include any number of pixels. For example, the number of pixels may be from 64, 100, 200, 500, 1000, 5000, 10,000, or 100,000 pixels up to 500,000, 1,000,000, 2,000,000, 3,000,000, 4,000,000, 5,000,000, or more pixels, including any combination thereof. In some embodiments, the number of pixels may be from 64-5,000,000 pixels.

The detector may be any appropriate detector based on the principle of thermal sensing, i.e., where a sensing element changes temperature in response to radiation, capable of having a spectral power response (and preferably an even spectral power response/sensitivity) across the shortwave wavelength range (which is generally from about 0.2 to about 2 μm). In some embodiments, the sensor is configured to detect at least 0.2-2 μm wavelengths. This is distinguished from, e.g., quantum sensors that measure photons like phone cameras, etc.

In some embodiments, the detector may include a digital detector. In some embodiments, the detector may include an analog sensing element read by a digital circuit. In some embodiments, the detector may be a thermopile, such as a thermopile digital array detector. However, it is envisioned that other detectors, such as an appropriately coated and modified microbolometer, or an appropriately designed pyroelectric detector, could also work.

In some embodiments, the device may include a window 112 that at least partially seals the bare thermal sensor array detector. The window may be any appropriate window that is transparent to shortwave radiation (e.g., wavelengths of 0.2-2 μm). In some embodiments, the window may be CaF₂. The window may be disposed over the bare thermal sensor array detector, in a direction 114 normal to a detection surface 116.

The device may include a lens assembly 120. The lens assembly may be configured to pass shortwave radiation from 0.2-2 μm in wavelength to the bare thermal sensor array detector. In some embodiments, the lens assembly may comprise a single lens. In some embodiments, the lens assembly may comprise a plurality of lenses. In some embodiments, the plurality of lenses may include a first lens coupled to a second lens. The lens assembly may be disposed in front of the bare thermal sensor array detector, in a direction 114 normal to a detection surface 116. In some embodiments, the device is free of any component between the lens assembly and the bare thermal sensor array detector. In some embodiments, only the window 112 is between the lens assembly and the bare thermal sensor array detector.

The device may include a shutter 130 configured to have a first position 132 and a second position 134. The shutter may be non-transparent to shortwave radiation, such that shortwave radiation is prevented from passing through the shutter and reaching the lens assembly when the shutter is in the first position, and shortwave radiation is allowed to reach the lens assembly when the shutter is in the second position. In some embodiments, the shutter is configured to rotate around an axis at one end of the shutter to convert between the first position and the second position.

The shutter may be operably coupled to a servo 136. The servo may be configured to cause the shutter to move between the first position and the second position. For example, when the device is ready to detect radiation, the servo may be configured to cause the shutter to move form the first position to the second position.

The device may include at least one housing 150 at least partially surrounding the bare thermal sensor array detector and the lens assembly. The at least one housing may include a plurality of housings removably coupled together. The plurality of housing may include a first housing 152 configured to be disposed at least partially around the lens assembly. The plurality of housing may include a second housing 154 configured to be disposed at least partially around the bare thermal sensor array detector. The plurality of housing may include a second housing 156 configured to be disposed between the first housing and the second housing. Each interface 158 between the plurality of housings may include any appropriate means for coupling the components together. For example, in some embodiments, the interface may include one or more threads to allow the components to be screwed together. In some embodiments, the interface may include one or more protrusions or depressions to interact and prevent the components from separating. Other approaches known in the art may also be used; for example, in some embodiments, the interface may include one or more pins or screws to prevent coupled housings from separating.

The lens assembly may include an achromatic optical float glass lens pair. The achromatic optical float glass lens pair may have an anti-reflection coating, such as a visible light/near infrared (VIS-NIR) anti-reflection coating.

The at least one housing may define at least one opening 159 configured to allow short wave radiation to reach the lens assembly. In some embodiments, the at least one housing defines a single opening extending from a first surface to a second surface opposite the first surface. The lens assembly may be disposed within the single opening between the first surface and the second surface.

The device may include a lens shade 140 coupled to at least one of the plurality of housings 150 (such as first housing 152). The lens shade may be positioned to extend away from the at least one opening. The lens shade may be disposed in front of the housing, in a direction 114 normal to a detection surface 116.

The lens shade may include a first depression 142 configured to receive a portion of the shutter when the shutter is in the first position 132. The lens shade may include a second depression 144 configured to receive at least a portion of the shutter when the shutter is in the second position 134. In some embodiments, the second depression is configured to receive all of the shutter when the shutter is in the second position.

The device may include a pan/tilt assembly 160 operably coupled to the housing. The pan/tilt assembly may be a 2-axis pan/tilt assembly configured to have 360 degrees of motion in an azimuthal direction and 180 degrees of motion in elevation.

The device may include circuitry 170 operably coupled to the bare thermal sensor array detector.

As used herein, the term “circuitry” refers to, is part of, or includes, hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry. As used herein, the term “processor” refers to various elements or combinations of elements that are capable of performing a function in a device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of me above. This may include one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The circuitry may include one or more processor(s), and one or more non-transitory computer-readable storage devices. The circuitry (which may include one or more processor(s)) may be configured to, collectively, receive images from the bare thermal sensor array detector. The circuitry which may include one or more processor(s)) may be configured to receive a plurality of images from the bare thermal sensor array detector and stitch the plurality of images together to form one composite image. For example, by capturing images in rapid succession, rotating and/or adjusting elevation between each image capture, and then stitching the images together, the device may create a single panoramic image larger than each individual image, that may be, e.g., spherical, hemispherical, etc.

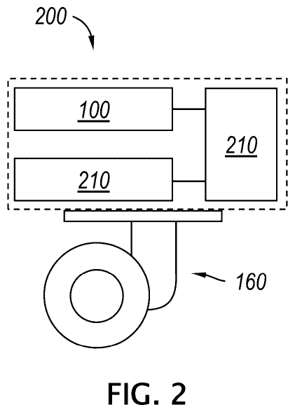

In various aspects, a system may be provided. Referring to FIG. 2, a system 200 may include a device 100 for measuring directionally and spatially resolved shortwave radiation as disclosed herein.

The system may include a longwave array detector 210. This may be, e.g., an array sensor with a plurality of pixels that measures the emitted thermal radiation of objects in the terrestrial temperature range, generally 250-350 Kelvin. The longwave array detector may be configured to detect wavelengths from, e.g., 4 μm, 5 μm, 6 μm, 7 μm, or 8 μm up to 15 μm, 20 μm, 25 μm, or 30 μm, including any subrange or combination thereof. For example, in some embodiments, the longwave array detector is configured to detect at least wavelengths of 8 μm-15 μm. In some embodiments, the longwave array detector is configured to detect at least wavelengths of 8 μm-20 μm. The longwave array detector may be a longwave thermopile array detector.

The system may include circuitry 220, such as one or more processors, that may be operably coupled to the device 100 and the longwave array detector 210.

The circuitry (which may include one or more processor(s), and may include one or more non-transitory computer-readable storage devices), may be configured, collectively, to receive images from the bare thermal sensor array detector and from the longwave array detector, and to combine the images to form a composite image.

In various aspects, a method for determining planar irradiance values may be provided.

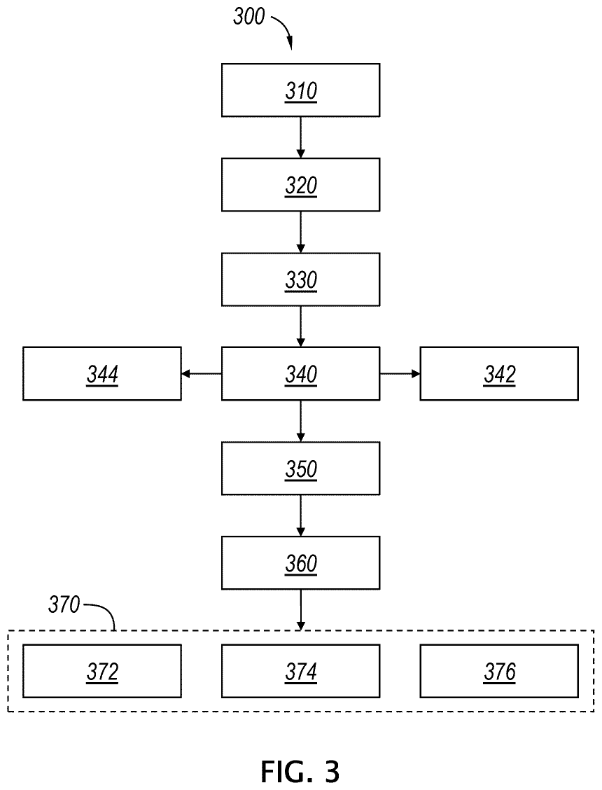

Referring to FIG. 3, a method 300 may include receiving 310 a first plurality of images from a device for measuring directionally and spatially resolved shortwave radiation as disclosed herein as disclosed herein. The method may include processing 320 the first plurality of images to evenly distribute pixel data points such that every pixel value in a 3D vector space has an equal solid-angle view factor. The method may include storing 330 a matrix of corresponding 3D vector coordinates.

The method may include generating 340 planar irradiance values based on the plurality of images and the matrix. The method may include transmitting 342 (e.g., to a remote server) and/or storing 344 (e.g., in a non-transitory computer-readable storage device) the planar irradiance values.

The method may include receiving 350 a second plurality of images from a longwave array detector. The second plurality of images may overlap the first plurality of images. The second plurality of images may substantially overlap the first plurality of images. The term “substantially overlap” indicates that at least 50%, at least 60%, at least 70%, at least 80%, or at least 90% of the field of view captured by one set of images is also captured by another set of images. For example, if a first set of images includes an entire house, and a second set of images includes only a window of that house, the second set of images would substantially overlap the first set of images, because 100% of the field of view (the window) would also be captured by the first set of images (the window is a subset of the entire house).

The method may include mapping 360 at least one pixel from the second plurality of images to correspond to at least one pixel from the first plurality of images. Comparing the first and second plurality of images, there may be a 1:1 correspondence of pixels. In some embodiments, there may be a 1:n correspondence. Depending on various factors, n may vary. In some embodiments, n may be, e.g., 0.2-5.

The method may include performing 370 one or more additional steps. The method may include determining 372 at least one biometeorology measurement based on the measured and resolved full spectrum of shortwave and longwave radiation, the biometeorology measurement including Global Horizontal Irradiance (GHI), Direct Normal irradiance (DNI), Diffuse Horizontal Irradiance (DHI), Sky View Factor (SVF), Global Tilted Irradiance (GTI), or a combination thereof.

The method may include classifying 374 a pixel based on a shortwave radiation value and/or a longwave radiation value mapped to the pixel. The classification may include comparing a shortwave radiation value from the pixel to a longwave radiation value mapped to the pixel. The classification may include comparing a shortwave radiation value and/or a longwave radiation value to a threshold. The classification may include an environmental identification of the pixel (e.g., sky, sun, ground, water, etc.). The classification may include identifying buildings, people, or objects (e.g., trees, buildings, people, vehicles, etc.). In some embodiments, the classification may include considering the values of only the pixel in question. In some embodiments, the classification may include considering the values of pixels adjacent to the pixel in question.

The method may include performing 376 at least one heat transfer analysis based on the first plurality of images and the second plurality of images. The heat transfer analysis may include a thermodynamic analysis of human comfort in a given environment. The heat transfer analysis may include an analysis of heat flow into, out of, and/or around a building or structure.

### Example

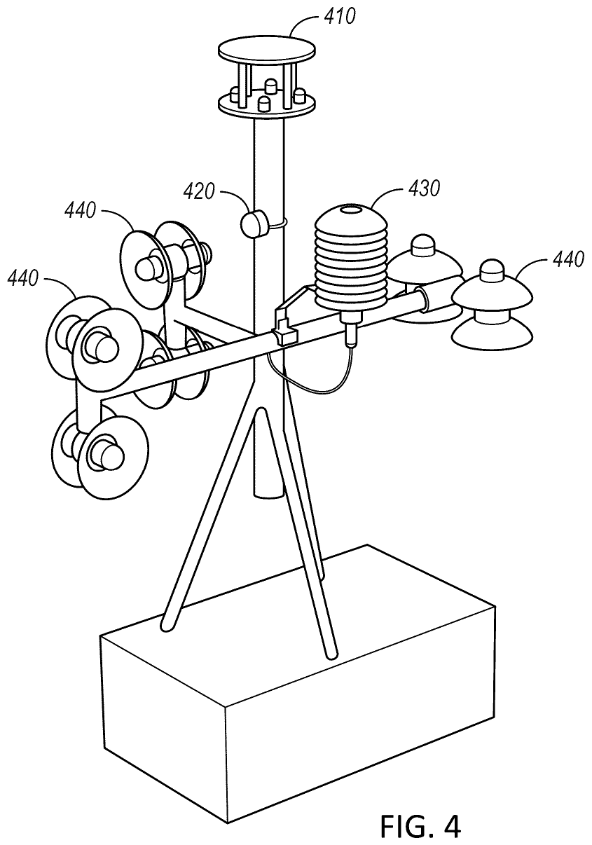

This study uses an embodiment (“SMART-SL”) of the disclosed system that records 360° shortwave and longwave panoramic images, which is deployed alongside a mobile human-biometeorological station (MaRTy cart) across locations at Arizona State University (ASU) in Tempe, Arizona for two hot clear days. The MaRTy cart can be seen in FIG. 4. The MaRTy cart setup is the same as described in Aviv et al., 2021. It is a human-biometeorological platform (FIG. 2), which was custom-built to be a mobile platform that is easily moved from location to location, and includes a wind speed sensor 410, a GPS sensor 420, a temperature/relative humidity (T/RH) probe 430, and net radiometers 440. The MaRTy sensor platform records location (lat/lon, °), air temperature (° C.); relative humidity (RH %); wind speed (m·s⁻¹); longwave (W·m⁻²) and shortwave (W· m⁻²) radiant flux densities in a 6-directional Hukseflux NR-01 net radiometer setup. It determines MRT from combining net radiometer readings of directional shortwave and longwave radiation, weighting each direction according to angular factors of a standing person as per Equation 1:

$${T}_{MRT} = \sqrt[4]{\frac{{\sum }_{i = 1}^{6} {W}_{i} ( {a}_{k} {K}_{i} + {a}_{i} {L}_{i} )}{{a}_{l} * σ} - 273.15 K} \qquad ( 1 )$$

where aₖ=0.70 and aᵢ=0.97 are the unitless absorption coefficients for short-wave and longwave radiant flux densities, σ is the Stefan-Boltzmann constant in Wm⁻² K⁻⁴, and the unitless angular weighting factors of Wᵢ=0.06 for the up and down facing sensors and Wᵢ=0.22 for the sensors pointing in each cardinal direction.

Experiments were carried out on two consecutive days in May on the ASU campus in Tempe Arizona. On each day the MaRTy cart and SMART-SL sensor platforms were set up at different locations in approximately 2-hour increments between 8:00 am and 5:30 pm. Readings were recorded from each device, panoramic photos were taken of the sites, and the albedo and emissivity of the surfaces were estimated.

There were five sites tested. These varied in conditions from grass to concrete with varying levels of sky exposure. These were selected to try to achieve a variety of representative scenarios with varying sky, sun, horizon, ground cover, and ground temperature. The five sites were tested across two days. One site was measured on both days to have a reference (Hayden Lawn).

First, the SMART-SL sensor took one complete measurement which took approximately 16-17 minutes to complete. Second, MaRTy is placed at the same location and measures for approximately 1 minute which includes 20 seconds to account for the sensor lag of the net radiometers and temperature sensor. Deploying and measuring with both MaRTy cart and SMART-SL sensor requires just below 20 minutes per location. Measuring three locations requires approximately one hour including the walk between locations.

On the first day, May 18th, the sensors were deployed in three locations 1) The Hayden Lawn, a large open grass field, 2) The MU PV Canopy, an outdoor seating area under a large PV shade structure; 3) The Forest Ave COOR, a concrete open area in front of the Lattie F. Coor Hall at ASU. Five measurements were made at Hayden lawn, Six at the MUPV Canopy, and four measurements were made at Forest Ave COOR all spaced approximately 2 hours apart with the Hayden and MU PV starting between 8 and 9 am with the MUPV having an additional data collection between 9 and 10 am due to data loss between 8 and 9 am.

On the second day, May 19th, the sensors were rotated through three locations, again 1) Hayden Lawn (reference location), 2) Parking lot, an open area dominated by asphalt concrete, and 3) COOR canyon, a concrete walkway between buildings near the Coor Hall.

### SMART-SL Short and Longwave Mapping

The disclosed system includes short and longwave (SMaRT-SL) thermopile array detectors. It is composed of four directional radiative energy sensors mounted on a 2-axis rotation stage, capable of 360 degrees of motion in the azimuthal direction and 180 degrees of motion in elevation for on-demand full spherical coverage of all four sensors. In this implementation, servos are used to drive reduction gears on each rotation stage, allowing for high directional accuracy and power and communication cable pass-throughs inside the centers of the reduction gears. The system is controlled by an Arduino DUE microcontroller.

The sensor package consists of: an Apogee Instruments SP-510 Thermopile pyranometer, an Apogee Instruments SL-510 pyrgeometer, a Heimann HTPA 80×64d R2 L10.5/0.95 F7.7HiC thermopile array thermal camera, and a novel custom-made thermopile array shortwave camera using a HTPA 80×64d R2 L0 FCaF₂ thermopile sensor.

The addition of this shortwave (here meaning UV to SWIR sensitivity) thermopile camera to the conventional longwave IR thermal camera allows for explicit directional and spatial quantification of all significant radiative components of thermal comfort. The single-value pyranometer and pyrgeometer measurements are then used as comparative reference signals, and the pyranometer was additionally used for initial calibration of the sensitivity coefficient of the shortwave thermopile sensor.

The Apogee Instruments pyranometer and pyrgeometer are measured using an ADS1115 16-bit precision, differential ADC with a resolution of 3.9 μV. The pyrgeometer thermistor channel is read with a standard 12-bit ADC for a resolution of 0.8 mV. The sensor specifications and errors are shown in Table 1.

TABLE 1
(Apogee sensor specifications)

| | SL-510 | SP-510 |
|---|---|---|
| | pyrgeometer | Pyranometer |
| Calibration uncertainty | 5% | 5% |
| Measurement repeatability | <1% | 1% |
| Long-term drift | <2% per year | <2% per year |
| Non-linearity | <1% | <1% |
| Spectral range | 5-30 μm | 385-2,105 nm |
| Temperature response | <5% from −15 | <5% from −15 |
| | to 45 C. | to 45 C. |
| Window heating offset | <10 Wm⁻² | <2 Wm⁻² |
| Uncertainty in daily total | 5% | 5% |

The Heimann HTPA 80×64d R2 L10.5/0.95 F7.7HiC thermopile array has 5,120 elements, and a field of view of approximately 39 by 31 degrees. The f/0.95 lens has a LWP coating with a cut-on (Tr: 5%) at 7.7 μm±0.3 μm. The accuracy is ±3% |TO−TA| or ±3K (whatever is larger) for object temperatures <300° C. and ambient temperatures from 5° C. to 50° C., and the NETD is 140 mK@1 Hz.

The shortwave thermopile array sensor combines a lensless, unfiltered thermopile array with a VIS-NIR coated achromatic optical float glass lens pair. The result is a low-resolution camera with near-flat spectral response from 375-2500 nm. The HTPA 80×64d R2 L0 FCaF2 thermopile sensor has an ˜1 mm thick CaF2 window to seal the device, which provides nearly flat bandpass response across the 200 μm to approximately 10,000 μm range. The focusing lens is a N-BAF10/N-SF5 achromatic pair with 14 mm focal length and 12.5 mm diameter for an f-number of 1.15. A VIS-NIR (400-1000 nm) anti-reflection coating reduces glare across the primary portion of the spectrum, and has a 50% signal range from 375-2650 nm. A rectangular lens hood further reduces lens flare, an on-going issue due to the strength of the direct beam sun. Finally, a servo actuated shutter-flap is used to darken the device for zeroing and calibration of thermal offsets. See, e.g., FIG. 1.

The SMART-SL can complete a full set of measurements over a 15 minute period. To calibrate, upon power up, a tripod base is used to align the sensor in the North direction. Next, the sensor system rotates to the Up, North, East, South, West and Down directions, pausing at each for approximately 30 seconds to record the Apogee Instruments Pyranometer and Pyrgeometer readings, creating a full 6-direction net radiometer measurement with only two sensors. After this 6-direction measurement is completed, the shutter is closed on the SW thermopile camera and the raw voltage outputs of the thermopile are read and averaged over approximately 30 seconds. This provides the baseline signal level offset due to the temperature dependent longwave IR emission of the optical elements.

After this calibration is run, the device begins the panoramic scan, achieving full spherical coverage from 70 images with small overlaps over about 8 minutes. After the panorama is completed, a follow-up SWIR camera calibration and 6-direction net radiometry is taken.

### SMART-SL Sensor Image Processing

The SMART-SL sensor raw data, in the form of a collection of images, is post-processed to create a Lambert cylindrical equal-area projection of the full scene. This process distributes, upscales, smooths and averages the overlapping images, and also serves the important role of evenly distributing pixel data points to have equal solid-angle view factors. The image pixels are binned and spaced at integer values in a discrete uniform distribution in the horizontal and vertical dimensions in the final projection, assuring that in 3D vector space every pixel value in the projection image has an equal solid-angle view factor. A matrix of corresponding 3D vector coordinates is saved with the image, allowing further calculations to then be done in the projection space utilizing this even point spread.

To generate the planar irradiance values for a given direction from the SMART-SL data, virtual pyranometer and pyrgeometer models were used to generate singular numbers. The 3D vector coordinates of the pixels were used to apply Lambert's cosine law to weight the data points within view of the simulated plane. This allowed the generation of not only cardinal direction planar irradiance values to match the experimental pyranometer and pyrgeometer data, but of any arbitrary plane direction as well.

A further insight made possible by both the unique resolution and paired sensor setup of the SMART-SL allowed for very accurate classification of any given pixel in the projection of the scene as having either terrestrial, sky, or direct solar origins. This was made possible by using logic that paired the longwave and shortwave images: if the longwave reading was more than 25° C. below ambient temperature the reading was classified as ‘sky’. If the shortwave was above 1,000 W·sr⁻¹·m⁻², the reading was classified as ‘direct sun’, and all other points were classified as ‘ground’. This method proved quite robust, however additional classifications can be included to distinguish, e.g., clear sky from cloudy sky, etc.

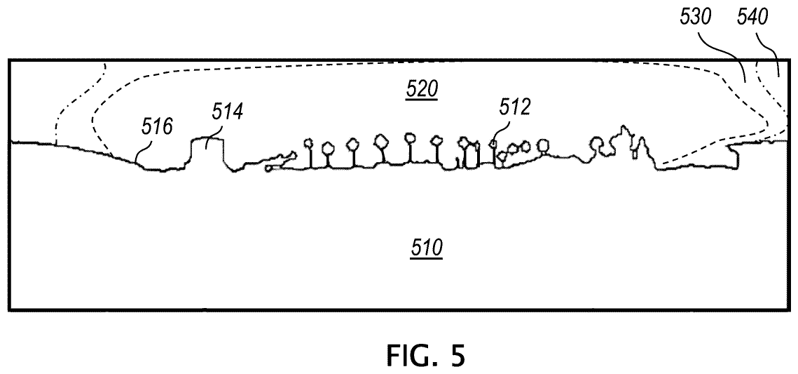

FIG. 5 is an example output showing the technique's ability to classify non-sky/ground 510, including trees 512, buildings 514, and the overall varying horizon line 516, as well as classifying various densities of cloud coverage in the sky (areas 520, 530, 540). This classification allows for both the quantification in any given measurement of the individual contributions of direct and reflected sources, as well as calculation of statistics, such as Diffuse Horizontal Irradiance (DHI) and Direct Normal Irradiance (DNI).

### Simulation Methods

For shortwave irradiance simulation, a ray-tracing model was constructed using Honeybee (version 0.66), a validated environmental plugin in the Rhino/Grasshopper algorithmic 3D modeling platform. With the inputs of the location (Phoenix, USA, 33°25′ N, 111°56′ W), the dates and times of the experiments, and the direct normal irradiance and diffuse horizontal irradiance, the model firstly generates the sky matrix for each simulation case. The resolution for determining the sun's location is one hour. The sun path and the sun location during the experiments were identified. The hourly global horizontal irradiance was collected in a weather station of the Arizona Meteorological Network, which is located in the central Phoenix and around 16 kilometers away from the experimental sites. However, the meteorological data does not include direct normal irradiance and diffuse horizontal irradiance. In order to estimate the aforementioned two parameters, the Typical Meteorological Years (TMY) dataset provided by ISD (US NOAA's Integrated Surface Database) contains the irradiance data and was used as reference. Based on the combination of the two sources, the estimated direct normal irradiance and diffuse horizontal irradiance were calibrated.

For the geometric modeling, the 3D model of buildings, land surfaces of different types and trees were built and the reflectivity coefficients of all surfaces were assigned based on measurements at each site after experiments with an ASD FieldSpec 4 Spectroradiometer, with reflectivity values averaged over the 350-2500 nm wavelength measurement range: 0.11 for asphalt ground, 0.2-0.25 for pavement, 0.5 for vegetation, 0.3 for gravel, 0.4 for photovoltaic panels, 0.3 for concrete, 0.15 for brick, 0.2 for trees. For each simulation case, a spatial map showing the mean spherical irradiance variation was created with a testing plane at the height of 1.1 m above the ground representing the centroid of humans and the testing points were generated in the resolution of 1 m. Boxes centered on the testing points were separated into six surfaces for plane irradiance calculation and the results correspond to the east, west, south, north, upward and downward orientations respectively. Based on these inputs, the Radiance engine embedded in Honeybee was used to build a ray-tracing model for irradiance simulation. The plane irradiance of all testing boxes' surfaces can be calculated, based on which the mean spherical irradiance was calculated using a cubic method. This simulation technique has been developed in previous studies (see, e.g., Aviv et al., Generation and Simulation of Indoor Thermal Gradients: MRT for Asymmetric Radiant Heat Fluxes. Proceedings of Building Simulation 2019. Building Simulation, Rome, Italy, the contents of which are incorporated by reference herein in their entirety).

In order to investigate the reflectivity of the surrounding environment and its influence on the irradiance received on the ground, a parallel set of simulations was conducted for each case with the reflectivity coefficients of all surrounding surfaces as 0 while keeping other settings unchanged. The parallel test still includes the indirect irradiance from the sky rather than from the surfaces in the built environment such as building envelopes, since the maximum number of diffuse bounces computed by the indirect calculation were four for all cases.

### Results

Selected sets of results from the five locations best illustrate the data that can be resolved by combining these techniques. Illustrative datasets were collected from the Forest Ave site next to the COOR building, the Hayden Lawn, and the MUPV shade canopy. These provide a range of shortwave and longwave conditions that expose the role of longwave outdoors, and terrestrial sources of reflected shortwave, both of which are often assumed to be small relative to direct sky solar radiation. These are not only significant, but have highly variable distributions that affect the heat experienced by people across short areas, and make shaded areas capable of significant heat stress.

### Longwave and Shortwave Radiant Energy Spherical Panoramas

First, results of the longwave and shortwave high-resolution scans collected by the SMART-SL platform can be considered. False-color images similar to thermal imaging were created, but in this case the gradient was representing the Wsr⁻¹ m⁻² coming from that direction. For each site, a visible-light panorama was also shown for reference to make it easier to interpret the sources and structures that appear in the radiant panoramas. Each composite image is a full 360-degree panorama, and the significant variation in thermal radiation is clear.

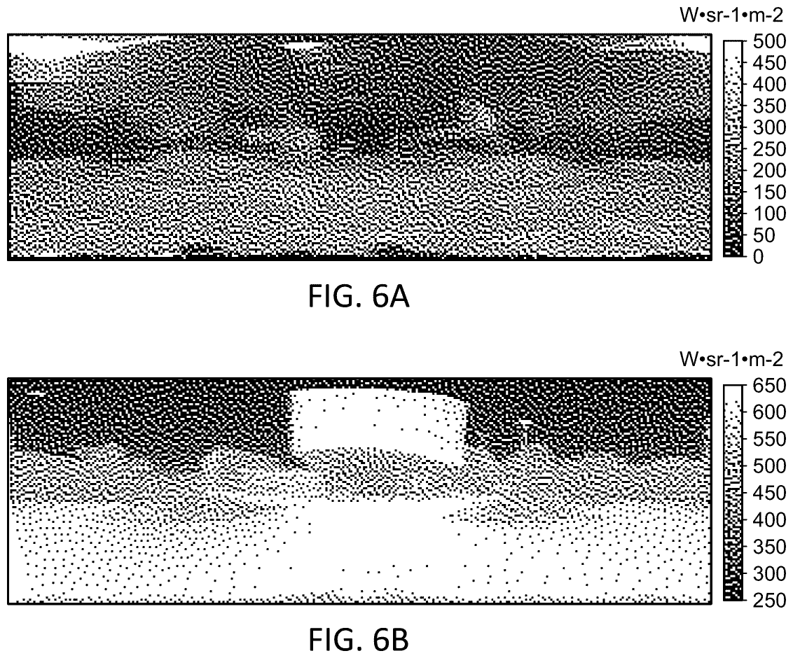

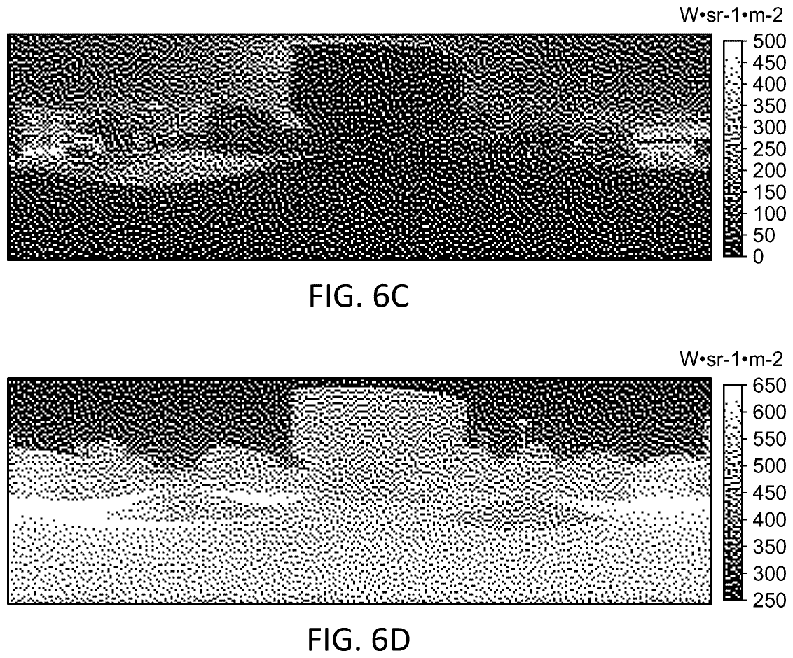

In the case of Forest Ave, there are images for two times, one at 11 am (FIGS. 6A and 6B) and one at 3 pm (FIGS. 6C and 6D). The shortwave values (FIGS. 6A and 6C) change dramatically from 11 am to 3 pm as the sun passes behind the COOR building and creates a large shaded area. Still there remain non-insignificant sources of reflected shortwave that are of similar, and in some areas greater, than the diffuse sky intensity. The longwave images (FIGS. 6B and 6D) are also very interesting for Forest Ave as the building plays a significant role as a heat source as does the hot concrete on the ground. At 2 pm the shade creates an obvious reduction in shortwave, but although the longwave has reduced without the direct heating from the sun on the surfaces, it still represents a significantly high source of radiant heat, and in the case of the building, it is blocking what would otherwise be thermally cool longwave sky.

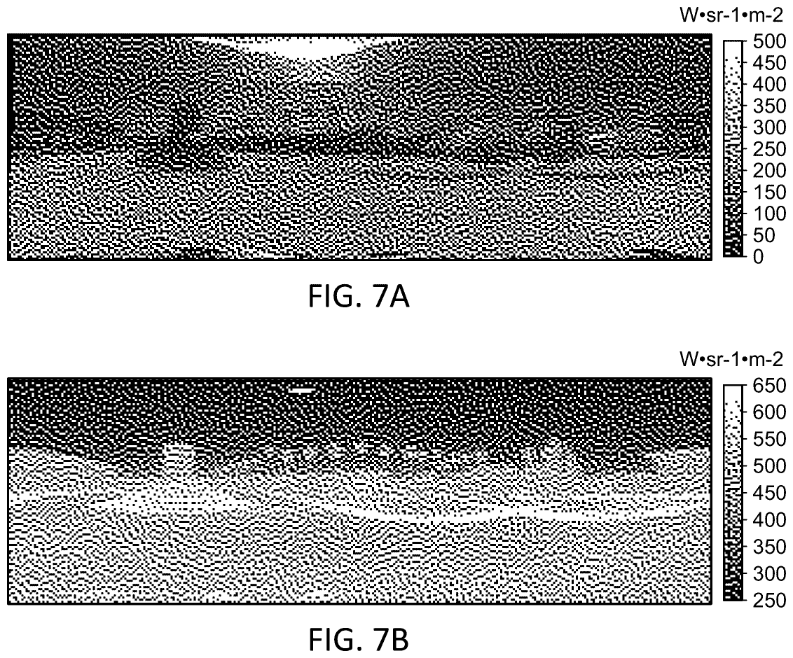

The Hayden lawn data (FIGS. 7A and 7B) is representative of large open areas. The shortwave data (FIG. 7A) again illustrates the significant reflection from the surrounding surfaces. Here the longwave component (FIG. 7B) is more significant as the major shift in temperature from the grass to the concrete causes a major change in the radiant heat. The radiant heat from the grass surfaces is about 10-20% lower than the concrete surfaces. This shift in heat of going from standing on the lawn to standing on concrete would be equivalent to the air temperature changing by several degrees. The SMART-SL sensor data allows one to not only calculate the radiant temperature fields in main directions, but to now visualize the role that all designed surfaces in an environment play in the thermal load placed on people using the spaces.

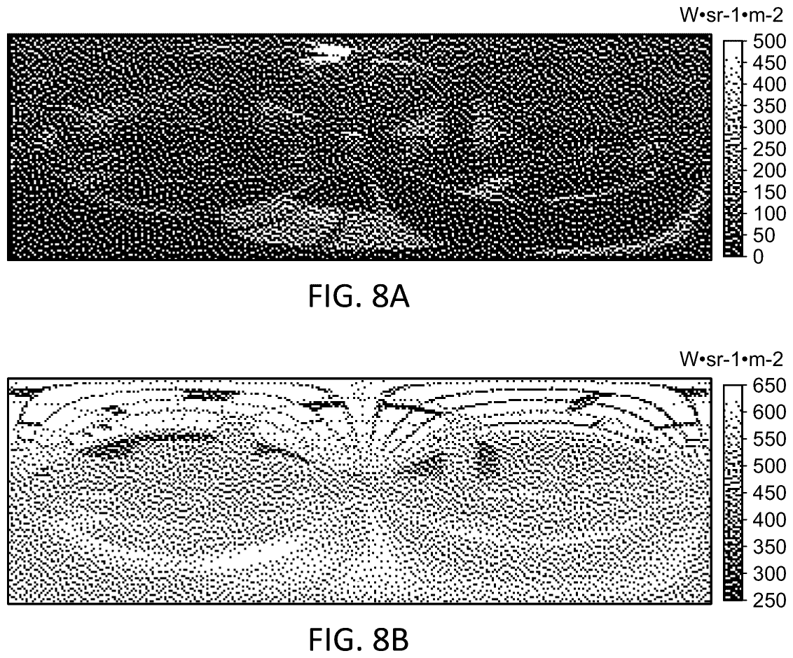

The MUPV canopy (FIGS. 8A and 8B) presents one of the most interesting radiant datasets for the high resolution measurement case study. The variation of openings in the canopy and the significant heating of the panels cause unique shortwave and longwave conditions. While the overall amount of shortwave (FIG. 8A) is certainly reduced by the canopy shading, there is still significant amounts of shortwave that arrives through the gaps in the canopy. This can largely be avoided by users as needed because the hot spots clearly register in the visible image, but it is noted that these measurements, even across a few inches, could be dramatically influenced by the highly variable shadows cast by the system, and passing through the space users would still experience these small spaces of shortwave radiation as well as the reflections from them which are generally not considered heat source but nevertheless have an effect.

What is more critical and fully unseen is the added longwave heat (FIG. 8B) emitted by the panels as they are heated in the sun and radiate down in the longwave. The shaded canopy actually blocks out the sky with a surface that is as hot as hot pavement. While blocking the sun is critical to mitigate shortwave, the rest of the sky acts as an important longwave radiant heat sink. The SMART-SL system can clearly display both the significant longwave radiant heat from the panels, and then also show how the sky's potential as a longwave radiant sink, or cooler, is obstructed by the panels.

### Longwave Directional Irradiance

Next the results for the longwave data resolved across principle directions for the various instruments can be considered. Longwave data similar to previous work was acquired, taking readings using the standard net radiometer measurements from MaRTy. For the SMART-SL sensor an improved array detector enabled more rapid acquisition of high-resolution longwave panoramas. The results were plotted, including distinguishing a fraction from the sky and a fraction from the ground. The Apogee Pyrgometer that was mounted on SMART-SL for additional verification did not produce accurate data, most likely due to overheating in the hot Arizona temperatures.

The longwave data shows consistently higher values for the terrestrial down direction, up to 615 W· m⁻² for the ground on Forest Ave, and the sky in the up direction has lower values as expected, at 366 W· m⁻² for the sky on Forest Ave. This MUPV canopy significantly increases the up directions longwave irradiance due to the high temperature PV panel canopy. So, while providing shade, the PV canopy actually has the highest longwave heat impact in the scene. One can also see temporally the effect of the Forest Ave COOR building shading the ground in the afternoon causing a reduction in the longwave, while similarly to the MUPV canopy causing increased longwave in the up direction due to the presence of the hot building and reduced view to the cooler sky.

There is good agreement between the MaRTy and SMART-SL data, with the biggest discrepancy coming from the up direction where the significant sky portion may not be read with the same spectral sensitivity by the detectors due to filter cutoffs of the longwave sensor's components, as well as differing error modes such as self-heating. Generally, an increased sky fraction caused the SMART-SL reading to be reduced compared to the MaRTy reading. Still, the results are a significant improvement over previous work.

### Shortwave Directional and Total Irradiance

The results of the new SMART-SL shortwave array sensor also show relatively good agreement for Forest Ave at 10 am and Hayden lawn at 2 μm. In this case there was also additional comparative data from the Apogee Pyrometer mounted on SMaRT-SL and from the shortwave simulation carried out to compare results from the SMART-SL array broken down into sky and reflected surfaces. The Forest Ave 3 μm and MUPV data are both shown on different scales because there was not direct sunlight, and in particular that limited the shortwave intensity for the Forest Ave 3 pm data. It has a maximum of just over 100 W· m⁻², but in the morning in the sun it was nearly 1000 W· m⁻² in the upward sky direction. The MUPV data illustrates the intense local variations possible due to the PV panel shading-small differences in the physical size and location of the sensors yields highly variable results. Hayden Lawn illustrates how the reflected portion is both dominating and significant in the north and east directions-due the clear skies, the diffuse shortwave radiation from the sky is quite low. The comparison of Forest Ave at 11a and 3 pm shows the significant differences of shading. On Forest Ave the sun went behind the building at 3 pm. both in the upwards and downwards directions, with a further marked change of the reflected portions in the cardinal directions dominating the overall radiative load. The variation among the data at Forest Ave at 3 pm is likely due to the increased difficulty of parsing out the much lower overall signals from an accurate accounting of the roughly 450 W· m⁻² incident on the thermopile sensors due to the radiant temperature of the longwave-emitting, shortwave transparent lens system. A similar error mode can be found in low intensity pyranometer measurements.

A significant conclusion borne out by both the simulation and the SMART-SL sensor data is in the significance of the reflected portion of the spectrum to the overall radiative load. For the respective datasets, a simple accounting comparing the up and down pyranometer data shows the downwards reflected portion as 22.5%, 18.2%, 21%, and 2.8% of the upwards direction, compared to a more accurate accounting of the ratio of the total spherical irradiance as 32.4%, 45.9%, 33.5%, and 36.7% by an average of the SMART-SL and simulation data. The simple pyranometer comparison belies the significance of the reflections to the overall radiative heat transfer in lacking a more precise way of accounting for reflections. Furthermore, the accounting of reflections not just in the downwards direction holds significance for human thermal comfort, as the downwards direction has lesser impact on a standing human form.

### Shortwave Reflected Radiant Heat

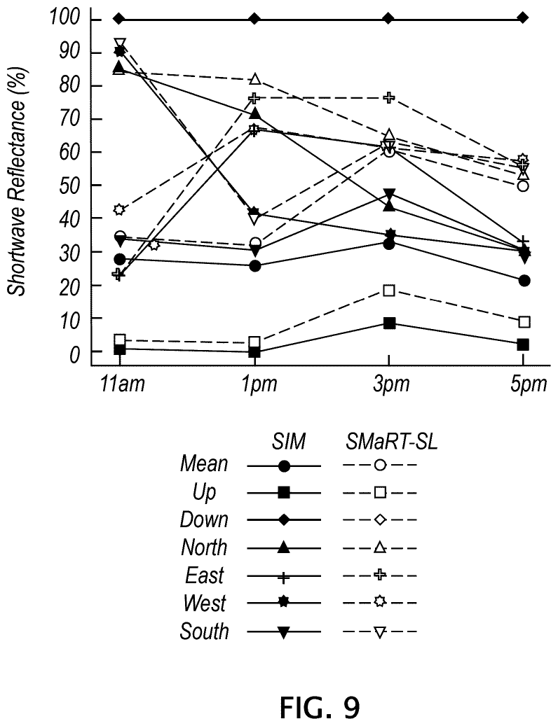

FIG. 9 shows an example (here, of data from Forrest Ave) of variation in the fraction of reflected shortwave. Here we have data taken directly from the SMART-SL as well as from the simulation (SIM), which were both able to resolve shortwave arriving from the sky and direct sun as well as shortwave reflected off terrestrial surfaces. There is again relatively good agreement between simulation and the sensor. The discrepancies arise when the scene is shaded and there is more significant variation at the site of the measurement.

Improving the measurement and understanding of shortwave reflections is of particular interest because in practice the reflection of shortwave radiation off of terrestrial surfaces is often considered insignificant relative to the direct solar and sky radiation. The reflected sources of radiation ranged from 10% to 70% of the total, with the open Hayden lawn receiving a more consistent range of 25-35%. In addition, one can see both the temporal and directional dependencies of the reflected shortwave. Across the three locations, reflected shortwave was a strong component of the total radiative heat load, with certain local conditions like highly reflective buildings causing it to even become the dominant portion. By breaking the data down by direction, one can see that a simple accounting of the shortwave as simply being driven by direct radiation from the sky is highly incomplete. Furthermore, the significant variations seen in this data show the importance of more accurate and spatially resolved accountings provided by the SMART-SL and simulation methods to better understand the complex influences of the reflected radiative sources.

The north, south, east, and west directions provide insights into how the sun reflects off of different surfaces throughout the day, and to the high variability of heat experienced from the non-direct sources of shortwave radiation. In all cases the down direction clearly only provided reflection, but interestingly the up direction was not just direct and included reflections as well.

For FIG. 9 (at Forest Ave), the mean spherical irradiance keeps decreasing from 11 am (when it reaches the peak 320.4 W· m⁻²). The percentage of reflected portion in the mean spherical irradiance remains around 30%, with the highest as 32.9% at 3 μm and lowest as 26.5% at 5 μm. The avenue in the south-north direction has a high H/W ratio with buildings on both sides. Clusters of trees are on the north side. The concrete pavement and grass are reflective. From the east the reflected percentage increases and reaches the peak 83.2% (58.1 W· m⁻²) at 3 μm, when the direct sun ray comes from the southwest direction and is reflected by the brick buildings, trees, grass and the concrete pavement. From the west the reflected percentage is high in the morning and reaches the peak 91.6% (119.8 W· m⁻²) at 11 am, and keeps decreasing after that, when the direct sun ray comes from the southeast direction and is reflected by the building with glass facade and the concrete pavement on the west side. From the north the irradiance reaches the peak 88.0% (110.5 W· m⁻²) also at 11 am, and has a decreasing trend afterwards. From the south the reflection percentage decreases to the lowest at 1 μm, and increases after that. The reflection percentage at around 4 pm (˜47%) is lower than that in the lawn (51.3%) and under the PV (62.3%). For the two open sites, the reflectance of the concrete pavement in the avenue is lower than that of grass in the lawn. The space under the PV shading structure has a brick building and trees on the south side which may contribute to irradiance from the south direction through multiple bounces, resulting in a higher reflection percentage.

For the MUPV, the Mean spherical irradiance does not fluctuate much during the day, with the highest as 89.1 W· m⁻² at 12 μm and lowest as 56.9 W· m⁻² at 4 μm. The percentage of reflected portion in the mean spherical irradiance does not vary much either, with the highest as 37.4% at 12 μm and lowest as 30.3% at 8 am. The irradiance from the upward direction (224.4 W· m⁻²) is lower than that in the lawn (797.6 W· m⁻²) without shade above. Because of the PV panels shading above with only some gaps between panels allowing direct sunlight, the shortwave irradiance received from every direction is lower than that in the open space such as the lawn. From the east direction the reflected percentage increases from 8 am and reaches the peak 87.6% (30.8 W· m⁻²) at 2 μm, when the direct sun ray comes from the southwest direction and is reflected by the columns made of brick and semi-transparent glass and the pavement. From the west the reflected percentage is high in the morning and reaches the peak 91.9% (35.3 W· m⁻²) at 12 μm, and the irradiance from the north direction is relatively high and reaches the peak 94.2% (41.5 W· m⁻²) also at 12 μm, when the direct sun ray comes from the south direction and is reflected by the brick building, trees and the pavement on the north side. The canyon in the west-east direction has a larger height-to-width ratio, which results in higher reflection percentage for the north direction. The South reflection percentage decreases from 8 am and reaches the lowest at 12 μm, and increases after that. It is around 40-60% with more direct rays received and mainly reflected from the pavement.

For Hayden Lawn, the mean spherical irradiance reaches the highest at around 12 μm. The irradiance coming from the up direction makes the largest contribution. The second highest is from the south direction in compliance with the direct sunlight direction. The reflected portion reaches the highest as 33% at around 12-2 pm. For the east direction the reflected percentage increases from 8 am and reaches the peak 86.6% (107 W· m⁻²) at 2 μm, when the direct sun ray comes from the southwest direction and is reflected by the brick building, trees and grass on the east side. For the west direction it is high in the morning and reaches the peak 89.9% (119.8 W· m⁻²) at around 10 am-12 pm, when the direct sun ray comes from the southeast direction and is reflected by the brick building, grass on the west side. From the north it is high at 10 am-2 pm with the peak over 90%, when the direct sun ray comes from the southeast/south/southwest direction and is reflected by the trees on the north side. From the south there are less obstacles for the direct sunlight from the south direction, the reflection percentage is around 40-60%, mainly reflected from the grass.

### Simulation of Radiant Heat Variation Reflection Contribution

A further ability of the simulation method is to create 2D spatial heat maps of the total spherical Irradiance across a site. These maps provide useful context for the reflected shortwave data points shown prior. One can see both the significant difference in intensity between just the direct incident radiation compared to a full accounting with reflections. The reflected portion can also be clearly seen as a strong driver of increased spatial variation in the overall irradiance.

Reflection and geometry comparison between all sites.

Table 2 provides an overview of the geometry of the site related to the height of surrounding infrastructure, terrain, or plants for all sites in the four horizontal directions.

TABLE 2
(Height-to-Width ratios (H/W))

| | Lawn | MUPV | Forest Ave | COOR | Parking Lot |
|---|---|---|---|---|---|
| East | 0.19 | / | 0.23 | / | 0.07 |
| West | 0.1 | / | 1.1 | / | 0.04 |
| North | / | 0.38 | / | 0.8 | 0.1 |
| South | / | 0.39 | / | 0.4/2.1 | 0.5 |

Table 3 gives the average reflected fraction of shortwave radiation for every site.

TABLE 3
(Average of reflection, bold italics values indicate the highest reflected
percentage for a given direction across the different sites.)

| | Lawn | MUPV | Forest Ave | COOR | Parking Lot |
|---|---|---|---|---|---|
| Mean Spherical | 31.4% | 34.5% | 30.5% | 25.9% | 18.1% |
| East | 59.2% | 61.1% | 61.3% | 63.7% | 57.4% |
| West | 51.7% | 54.1% | 41.6% | 39.4% | 28.7% |
| North | 79.8% | 83.1% | 70.0% | 77.9% | 56.4% |
| South | 41.3% | 44.9% | 41.5% | 39.7% | 34.8% |
| Up | 1.6% | 6.9% | 2.8% | 4.0% | 1.1% |
| Down | 99.9% | 100.0% | 100.0% | 100.0% | 99.9% |

A summary of the overall results of the reflections across all sites is as follows:
Open spaces such as the Parking Lot have a relatively low percentage, while the Lawn has a high percentage because of the high reflectance of the grass.
For other three sites in urban canyons, the shading structure increases the reflection percentage of MUPV, while its H/W ratio is lower than that of Forest Avenue and COOR.
Forest Avenue has a high average reflection percentage in the East direction, due to the concrete facade of the buildings on the east side besides the reflective ground.
MUPV has the highest reflection percentage in general, however the mean spherical irradiance is the lowest during the day among all sites, which is attributed to the PV panels shading above with only some gaps between panels allowing direct sunlight.
The reflection percentage of COOR is high especially in the East direction, because the concrete facade of the building on the north side contributes much to the reflection especially when the sun ray comes in around the South direction. Even though the average reflection percentage of COOR in each direction is not always the highest, its peak during the day is always higher than that of other sites. Since there is less surface facing East or West, the reflection percentage is not always high during the day, resulting in the not so high average.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed:

1. A device for measuring directionally and spatially resolved shortwave radiation, comprising:
a bare thermal sensor array detector configured to have a plurality of pixels; and
a lens assembly configured to pass shortwave radiation from 0.2-2 μm in wavelength to the bare thermal sensor array detector;

2. The device according to claim 1, wherein the plurality of pixel comprises from 64 to 5,000,000 pixels.

3. The device according to claim 1, further a plurality of housings removably coupled together, the plurality of housings at least partially surrounding the bare thermal sensor array detector and the lens assembly, the plurality of housings defining at least one opening configured to allow short wave radiation to reach the lens assembly.

4. The device according to claim 3, further comprising a lens shade coupled to at least one of the plurality of housings, the lens shade being positioned to extend away from the at least one opening.

5. The device according to claim 1, wherein the lens assembly comprises a VIS-NIR coated achromatic optical float glass lens pair.

6. The device according to claim 1, further comprising a window comprising CaF2 that at least partially seals the bare thermal sensor array detector.

7. The device according to claim 1, further comprising a shutter configured to have a first position and a second position, such that shortwave radiation is prevented from reaching the lens assembly in the first position and allowed to reach the lens assembly in a second position.

8. The device according to claim 7, wherein the shutter is operably coupled to a servo, the servo configured to cause the shutter to move from the first position to the second position.

9. The device according to claim 1, further comprising a 2-axis pan/tilt assembly configured to have 360 degrees of motion in an azimuthal direction and 180 degrees of motion in elevation.

10. The device according to claim 1, further comprising a processor configured to receive images from the bare thermal sensor array detector.

11. The device according to claim 10, wherein the processor is configured to receive a plurality of images from the bare thermal sensor array detector and stitch the plurality of images to form one composite image.

12. A system for measuring radiation, comprising:
a processor;
a device according to claim 1 operably coupled to the processor;
a longwave array detector operably coupled to the processor.

13. The system according to claim 12, wherein the processor is configured to receive images from the bare thermal sensor array detector and the longwave array detector and combine the images to form a composite image.

14. A method for determining planar irradiance values, comprising:
receiving a first plurality of images from a device according to claim 1;
processing the first plurality of images to evenly distribute pixel data points such that every pixel value in a 3D vector space has an equal solid-angle view factor;
storing a matrix of corresponding 3D vector coordinates;
generating planar irradiance values based on the plurality of images and the matrix.

15. The method according to claim 14, further comprising receiving a second plurality of images from a longwave array detector, the second plurality of images substantially overlapping the first plurality of images.

16. The method according to claim 15, further comprising mapping a pixel from the second plurality of images to correspond to a pixel from the first plurality of images.

17. The method according to claim 16, further comprising determining at least one biometeorology measurement based on the measured and resolved full spectrum of shortwave and longwave radiation, the biometeorology measurement including Global Horizontal Irradiance (GHI), Direct Normal irradiance (DNI), Diffuse Horizontal Irradiance (DHI), Sky View Factor (SVF), Global Tilted Irradiance (GTI), or a combination thereof.

18. The method according to claim 16, further comprising classifying a pixel by comparing a shortwave radiation value from the pixel to a longwave radiation value mapped to the pixel.

19. The method according to claim 16, further comprising performing at least one heat transfer analysis based on the first plurality of images and the second plurality of images.
